(19) United States
(12) Patent Application Publication
(10) Pub. No.: US 2013/0301968 A1
(43) Pub. Date: Nov. 14, 2013

(54) HUB SPINDLE BEARING UNIT FOR WHEEL

(71) Applicants: Tatsuki Mori, Toyota-shi (JP); Arihiro Fujiwara, Nagoya-shi (JP)

(72) Inventors: Tatsuki Mori, Toyota-shi (JP); Arihiro Fujiwara, Nagoya-shi (JP)

(73) Assignee: JTEKT CORPORATION, Osaka-shi, Osaka (JP)

(21) Appl. No.: 13/981,428

(22) PCT Filed: Feb. 9, 2012
(86) PCT No.: PCT/JP2012/052981

§ 371 Date: Jul. 24, 2013

(30) Foreign Application Priority Data
Feb. 9, 2011 (JP) 2011-025979

(51) Int. Cl. B60B 27/00

(52) U.S. Cl. CPC B60B 27/0005
USPC 384/456

(57) ABSTRACT

A hub spindle bearing unit for the wheel is equipped with an inner ring having inner ring raceway surfaces formed on the outer peripheral surface of the shaft section itself of the hub spindle or an inner ring forming annular member formed separately from the shaft section, an outer ring member having outer ring raceway surfaces formed corresponding to the inner ring raceway surfaces, and balls rotatably disposed between the inner and outer rings, a groove section configured as a fragile section in which the strength against the shaft bending direction load exerted to the hub spindle is weaker than the strength of the hub spindle is formed in the outer ring member, and the groove section is deformed and broken earlier than the hub spindle when an excessive shaft bending direction load exceeding a load to be input during ordinary use is input to the hub spindle.

### TECHNICAL FIELD

The present invention relates to a hub spindle bearing unit for a wheel.

### BACKGROUND ART

Conventionally, a hub spindle bearing unit for a wheel in which a shaft section of a hub spindle integrated with a flange section capable of mounting the wheel is supported by a supporting member via a bearing has been known. The content thereof is disclosed in Patent Document 1, for example. The hub spindle bearing unit for the wheel disclosed in Patent Document 1 is equipped with the outer joint member of a constant-velocity universal joint constituting a part of a drive shaft, a hub spindle having a flange section for mounting a wheel, and a double row rolling bearing, these being formed into a unit. One of the double row inner ring raceways of this double row rolling bearing is integrated with the outer joint member. Furthermore, the hollow stem section of the outer joint member is fitted into the through hole of the hub spindle, and the hub spindle and the stem section are integrally secured by a diameter-expansion calked section by which the stem section is partially expanded in diameter and is calked. The strength of the smallest diameter portion of the above-mentioned drive shaft is set so as to be weaker than both the strength of the diameter-expansion calked section and the strength of the stem section. Since the relationship that the strength of the smallest diameter portion of the drive shaft is weaker than both the strength of the diameter-expansion calked section and the strength of the stem section is established, in the case that an excessive torque is input, the drive shaft is broken earlier, thereby preventing the hub spindle bearing unit for the wheel from being broken. In other words, a configuration of mechanical breakage preventing means is provided.

### PRIOR ART DOCUMENT

### Patent Document

Patent Document 1: JP-A-2007-320351

### SUMMARY OF THE INVENTION

### Problem that the Invention is to Solve

However, the hub spindle bearing unit for the wheel according to Patent Document 1 described above has a problem that it is not applicable to a driven wheel although it is applicable to a drive wheel. Hence, there is a need for breakage preventing means that is also applicable to a driven wheel. In addition, the hub spindle bearing unit for the wheel according to Patent Document 1 is configured so as to deal with excessive torque input, that is, only a load in a torsion direction. Hence, the configuration does not deal with shaft bending direction loads exerted to the hub spindle bearing unit for the wheel. For this reason, in the case that, among the shaft bending direction loads exerted to the hub spindle, an excessive shaft bending direction load exceeding a load to be input during ordinary use is exerted, there is a danger that the hub spindle may be broken.

Hence, the present invention has been made in consideration of these points, and an object of the present invention is to provide a hub spindle bearing unit for a wheel in which a shaft section of a hub spindle integrated with a flange section capable of mounting the wheel is supported by a supporting member via a bearing, and when, among shaft bending direction loads exerted to the hub spindle, an excessive shaft bending direction load exceeding a load to be input during ordinary use is exerted, the hub spindle can be suppressed from being broken.

### Means for Solving the Problem

According to the present invention, there is provided a hub spindle bearing unit for a wheel in which a shaft section of a hub spindle integrated with a flange section capable of mounting the wheel is supported by a supporting member via a bearing, characterized in that the bearing of the shaft section of the hub spindle includes: with an inner ring having inner ring raceway surfaces formed on an outer peripheral surface of the shaft section itself or an inner ring forming annular member formed separately from the shaft section and mounted on the shaft section; an outer ring having outer ring raceway surfaces formed corresponding to the inner ring raceway surfaces formed on the inner ring; and rolling elements rotatably disposed between the inner ring raceway surfaces of the inner ring and the outer ring raceway surfaces of the outer ring, a fragile section in which a strength against a shaft bending direction exerted to the hub spindle is weaker than a strength of the hub spindle is formed in at least one of the outer ring and the inner ring forming annular member, and the fragile section is deformed and broken earlier than the hub spindle when an excessive shaft bending direction load exceeding a load to be input during ordinary use is input to the hub spindle.

The shaft bending direction in the above-mentioned means is assumed to mean a direction in which the load is exerted in the radial direction of the shaft section of the hub spindle relative to the axial direction of the shaft section.

### Advantage of the Invention

In the hub spindle bearing unit for the wheel in which the shaft section of the hub spindle integrated with the flange section capable of mounting a wheel is supported by a supporting member via the bearing, when, among shaft bending direction loads exerted to the hub spindle, the excessive shaft bending direction load exceeding the load to be input during ordinary use is exerted, the hub spindle can be suppressed from being broken by taking the above-mentioned various measures according to the present invention.

### BRIEF DESCRIPTION OF THE DRAWINGS

FIG. 1 is an axial cross-sectional view showing a state in which a wheel is mounted on a hub spindle bearing unit for the wheel according to Embodiment 1 of the present invention;

FIG. 2 is an axial cross-sectional view showing the hub spindle bearing unit for the wheel, the area II of FIG. 1 being enlarged;

FIGS. 3(A) and 3(B) are axial cross-sectional views, the area III of FIG. 2 being enlarged; FIG. 3(A) is an axial cross-sectional view showing a state in which a ball (rolling element) rolls on a regular rolling raceway, and FIG. 3(B) is an axial cross-sectional view showing a state in which a ball (rolling element) runs onto an outer ring shoulder section where an outer ring raceway surface is formed from the regular rolling raceway and the ball is displaced;

FIG. 4 is an axial cross-sectional view showing a hub spindle bearing unit for a wheel according to Embodiment 2 of the present invention; and

FIG. 5 is an axial cross-sectional view showing a hub spindle bearing unit for a wheel according to Embodiment 3 of the present invention.

### MODES FOR CARRYING OUT THE INVENTION

Modes for carrying out the present invention will be described on the basis of embodiments.

### Embodiment 1

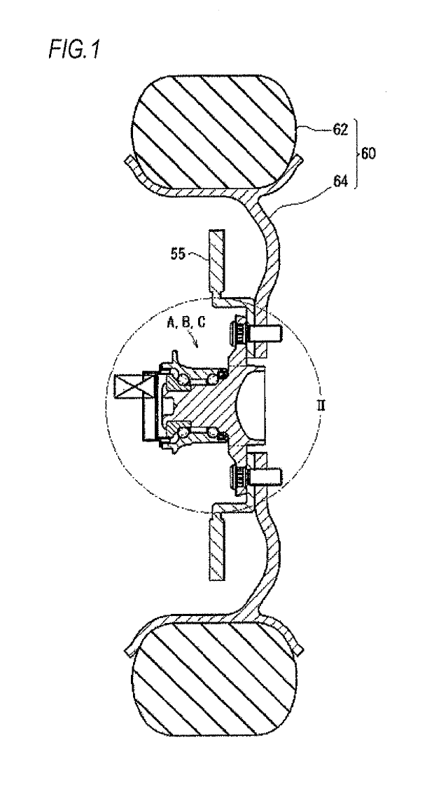

Embodiment 1 according to the present invention will be described referring to FIGS. 1 to 3.

As shown in FIG. 1, in a vehicle, a hub spindle bearing unit A for a wheel 60 is configured to support the wheel 60 composed of a tire 62 and a wheel element 64 on a suspension device (not shown) and to rotatably support the wheel 60 via a brake rotor 55.

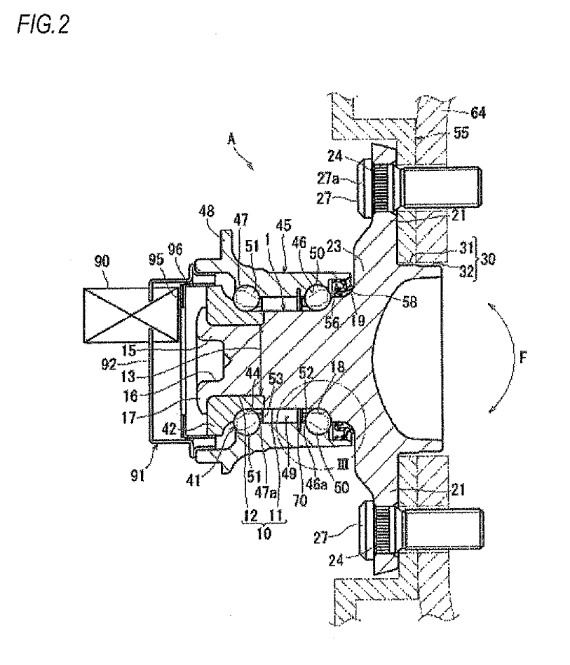

As shown in FIG. 2, in the hub spindle bearing unit A for the wheel 60 serving as a wheel hub unit, a hub spindle 1 integrated with a flange section 21 capable of mounting the wheel 60 (refer to FIG. 1) is integrated with a double row angular contact ball bearing 41 (bearing) serving as a bearing so as to be formed into a unit and further supported on a knuckle supported by a vehicle suspension device, not shown, via this angular contact ball bearing 41 (bearing). When the hub spindle bearing unit A for the wheel 60 is herein described, the basic configuration of the hub spindle bearing unit A will be described first, and then the specific configuration of a fragile section, described later, provided to suppress the hub spindle 1 from being broken will be described.

[Basic Configuration of Hub Spindle Bearing Unit A]

As shown in FIG. 2, the hub spindle 1 of the hub spindle bearing unit A for the wheel 60 (refer to FIG. 1) integrally has a shaft section 10 on which the angular contact ball bearing 41 (bearing) is mounted; a fitting shaft section 30 which is formed on one side of this shaft section 10 and has a diameter larger than that of the shaft section 10 and on which the center hole of the wheel 60 is fitted; a flange base section 23 positioned between the shaft section 10 and the fitting shaft section 30; and the flange section 21 radially extended in the outside diameter direction on the outer peripheral surface of this flange base section 23. In addition, bolt holes 24 in which hub bolts 27 for tightening the wheel 60 (refer to FIG. 1) are press-fitted and disposed are provided in the flange section 21 so as to pass therethrough. Furthermore, on the fitting shaft section 30, a brake rotor fitting section 31 corresponding to the brake rotor 55 is formed on the side of the flange section 21, and a wheel fitting section 32 corresponding to the wheel 60 (refer to FIG. 1) and having a diameter slightly smaller than that of the brake rotor fitting section 31 is formed on the side of the tip end thereof.

Moreover, the shaft section 10 of the hub spindle 1 of the hub spindle bearing unit A for the wheel 60 (refer to FIG. 1) is formed into a stepped shaft shape in which the section on the side of the flange section 21 has a large diameter and the section on the side of the tip end has a small diameter, and on the outer peripheral surface of the large diameter section 11 of the shaft section 10, an inner ring raceway surface 18 for one row of the double row angular contact ball bearing 41 (bearing) serving as a rolling bearing is formed. Besides, on the outer peripheral surface of the small diameter section 12 of the shaft section 10, an inner ring forming annular member 42 having an inner ring raceway surface 44 for the other row on the outer peripheral surface thereof is fitted. What's more, at the tip end section of the shaft section 10, an end shaft section 15 having the same diameter as that of the small diameter section 12 is extended. At the central section of the end surface of this end shaft section 15, a shaft end concave section 16 is formed, the tip end section of the end shaft section 15 is calked outward in the radial direction to form a calked section 17, whereby the inner ring forming annular member 42 is secured to the outer peripheral surface of the small diameter section 12. The inner ring raceway surface 18 of the shaft section 10 and the inner ring raceway surface 44 of the inner ring forming annular member 42 constitute an inner ring.

An outer ring member 45 (outer ring) is disposed while an annular space 49 is provided around the outer peripheral surface of the shaft section 10 of the hub spindle 1 of the hub spindle bearing unit A for the wheel 60. On the inner peripheral surface of the outer ring member 45, outer ring raceway surfaces 46 and 47 corresponding to the inner ring raceway surfaces 18 and 44 configured on the hub spindle 1 are formed with a predetermined distance provided therebetween in the axial direction. In addition, between the inner ring raceway surfaces 18 and 44 and the outer ring raceway surfaces 46 and 47, a plurality of balls 50 and a plurality of balls 51 (rolling elements) are disposed rotatably while being retained by cages 52 and 53, respectively. A required axial preload based on the calking force exerted when the end shaft section 15 of the shaft section 10 is calked to form the calked section 17 is applied to the plurality of balls 50 and the plurality of balls 51 (rolling elements) disposed between the inner ring raceway surfaces 18 and 44 and the outer ring raceway surfaces 46 and 47. Furthermore, a vehicle body side flange 48 is integrally formed at the axial intermediate section of the outer peripheral surface of the outer ring member 45. This vehicle body side flange 48 is secured with bolts to the mounting surfaces of the vehicle body side members, such as a knuckle, a carrier, and the like, supported by a vehicle suspension device, not shown. What's more, a sealing member 56 is press-fitted into the inner peripheral surface of one end section of the outer ring member 45 and mounted therein, and the tip end section of the lip 58 of this sealing member 56 is made slide contact with a sealing surface 19 formed adjacent to the shoulder section of the inner ring raceway surface 18 of the hub spindle 1.

A pulsar ring 96 having a to-be-detected section 95 corresponding to a speed sensor 90 in the circumferential direction is press-fitted and secured to the outer peripheral surface of the inner ring forming annular member 42 as necessary. In this case, a cover member 91 having a covered cylindrical shape is press-fitted into and secured to the inner peripheral surface of the end section of the outer ring member 45, and the speed sensor 90 is mounted on the cover plate section 92 of this cover member 91 while the detection section thereof faces the to-be-detected section 95 of the pulsar ring 96.

[Fragile Section Provided to Suppress Breakage of Hub Spindle 1]

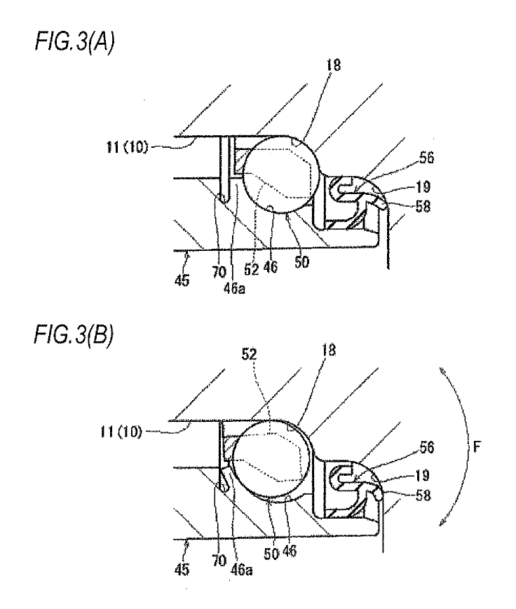

As shown in FIGS. 2 and 3(A), in the case that an excessive shaft bending direction load F exceeding a load to be input during ordinary use is input to the hub spindle 1 of the hub spindle bearing unit A for the wheel 60, the shaft bending direction load F is exerted to the shaft section 10 of the hub spindle 1. In the case that no fragile section is provided, a structure is formed in which the stress due to the shaft bending direction load F is concentrated in a connection section 13 serving as the boundary between the large diameter section 11 and the small diameter section 12 of the shaft section 10. Hence, the present invention provides a structure in which the stress is not concentrated in this connection section 13 by forming a fragile section that is deformed and broken earlier than the hub spindle 1 when the excessive shaft bending direction load F is applied. In other words, a fragile section having a strength weaker than that of the hub spindle 1 with respect to the strength against the shaft bending direction exerted to the hub spindle 1 is provided in the outer ring member 45 (outer ring).

The shaft bending direction of the shaft bending direction load F is assumed to mean the direction of the load exerted in the radial direction of the shaft section 10 relative to the axial direction of the shaft section 10 of the hub spindle 1.

In addition, the excessive shaft bending direction load F exceeding the load input to be input during ordinary use is assumed to mean a load or the like exerted to the hub spindle 1, for example, in the case that a vehicle spins and the wheel element 64 (refer to FIG. 1) collides with a road curb.

In the case that the wheel element 64 (refer to FIG. 1) collides with a road curb, a lateral load (a load in the axial direction of the hub spindle 1) is input to the flange section 21, whereby the load is exerted to the hub spindle 1 in the radial direction of the shaft section 10 relative to the axial direction of the shaft section 10. In other words, the load is exerted in a direction in which the shaft section 10 of the hub spindle 1 is bent.

This fragile section is configured by notching to form a groove section 70 around the entire circumference in the circumferential direction at a position adjacent to an outer ring shoulder section 46a where the outer ring raceway surface 46 of the outer ring member 45 (outer ring) is formed.

The groove section 70 may be configured by notching at a plurality of places in the circumferential direction at a position adjacent to the outer ring shoulder section 46a where the outer ring raceway surface 46 is formed. In the case that the groove section 70 is formed at a plurality of places, in consideration of the input direction of the shaft bending direction load F, it is preferable that the groove section should be formed at a position corresponding to the up-down direction of a vehicle in a state of being mounted on vehicle body side members, such as a knuckle, a carrier, and the like, supported by a vehicle suspension device. The position of the groove section 70 adjacent to the outer ring shoulder section 46a is disposed and configured so that the outer ring shoulder section 46a has a thickness so as to be deformed and broken by the input of the excessive shaft bending direction load P. The groove section 70 is applicable at positions adjacent to the outer ring shoulder sections 46a and 47a where the outer ring raceway surfaces 46 and 47 of the outer ring member 45 (outer ring) are formed. When it is assumed that the balls 50 and 51 (rolling elements) are displaced significantly by the input of the excessive shaft bending direction load F, it is preferable that the groove section should be formed adjacent to the outer ring shoulder section 46a where the outer ring raceway surface 46 disposed and configured on the side of the flange section 21 of the hub spindle 1 is formed.

FIG. 3(B) shows a state in which the outer ring shoulder section 46a is deformed and broken when the excessive shaft bending direction load F exceeding the load to be input during ordinary use is exerted to the hub spindle 1.

As shown in FIG. 3(B), when the excessive shaft bending direction load F exceeding the load to be input during ordinary use is exerted to the hub spindle 1, the excessive shaft bending direction load F is transmitted to the balls 50 (rolling elements) rolling on the outer ring raceway surface 46. Then, the balls 50 (rolling elements) are displaced so as to run onto the outer ring shoulder section 46a where the outer ring raceway surface 46 is formed from the regular rolling raceway, whereby the excessive shaft bending direction load F is exerted to the outer ring raceway surface 46. As a result, the excessive shaft bending direction load F is input to the outer ring raceway surface 46 via the balls 50 (rolling elements), and the stress is concentrated at the portion of the outer ring raceway surface 46 and the portion is depressed and deformed.

As described above, with the hub spindle bearing unit A for the wheel 60 according to the present invention, the groove section 70 serving as a fragile section is deformed and broken earlier than the hub spindle 1 when the excessive shaft bending direction load F exceeding the load to be input during ordinary use is input to the hub spindle 1, thereby absorbing and relieving the load and being able to provide a configuration in which the shaft bending direction load F is not concentrated in the hub spindle 1. As a result, when, among shaft bending direction loads exerted to the hub spindle 1, the excessive shaft bending direction load F exceeding the load to be input during ordinary use is exerted, the hub spindle 1 can be suppressed from being broken. In addition, the outer ring member 45 (outer ring) in which the groove section 70 serving as a fragile section is formed is configured for both a drive wheel and a driven wheel, whereby the above-mentioned configuration is applicable to both the drive wheel and the driven wheel.

Furthermore, since the groove section 70 serving as a fragile section is configured as a groove section formed around the entire circumference in the circumferential direction, the groove section 70 can be configured in the outer ring member 45 (outer ring) constituting the hub spindle bearing unit A for the wheel 60 without changing the material thereof and without increasing the weight thereof.

In addition, when the excessive shaft bending direction load F is exerted to the balls 50 (rolling elements) rolling on the outer ring raceway surface 46, the balls 50 (rolling elements) are displaced so as to run onto the outer ring shoulder section 46a where the outer g raceway surface 46 is formed from the regular rolling raceway, whereby the excessive shaft bending direction load F is exerted to the outer ring raceway surface 46. The groove section 70 is configured so as to be formed at the position adjacent to the outer ring shoulder section 46a by paying attention to the displacement of the balls 50 (rolling elements). Hence, the excessive shaft bending direction load F is input to the outer ring raceway surface 46 via the balls 50 (rolling elements), and the outer ring shoulder section 46a is deformed and broken, whereby the outer ring raceway surface 46 is deformed earlier than the hub spindle 1. As a result, the groove section 70 serving as a fragile section can be provided at a more effective position. Furthermore, at the position of the groove section 70 adjacent to the outer ring shoulder section 46a, the outer ring shoulder section 46a is disposed and configured so as to have a thickness so that the outer ring shoulder section 46a is deformed and broken when the excessive shaft bending direction load F is input, whereby the load can be absorbed more effectively. Moreover, as the outer ring shoulder section 46a is deformed and broken, the outer ring raceway surface 46 in this portion is also deformed eventually. As a result, abnormal noise and vibration occur when the balls 50 (rolling elements) roll over the deformed outer ring raceway surface 46. Hence, the user can easily detect that an abnormality has occurred in the hub spindle bearing unit for the wheel GO.

What's more, the shaft bending direction load F to be exerted to the hub spindle 1 is input from the side of the flange section 21 for mounting the wheel 60. Hence, when the excessive shaft bending direction load F is exerted, out of the rolling elements rolling on the outer ring raceway surfaces 46 and 47 of the outer ring member 45 (outer ring), the rolling elements rolling on the outer ring raceway surface 46 disposed and configured on the side of the flange section 21 of the hub spindle 1 are more displaced. For this reason, the groove section 70 is formed adjacent to the outer ring shoulder section 46a where the outer ring raceway surface 46 disposed and configured on the side of the flange section 21 of the hub spindle 1 is formed, whereby the load can be absorbed more effectively.

### Embodiment 2

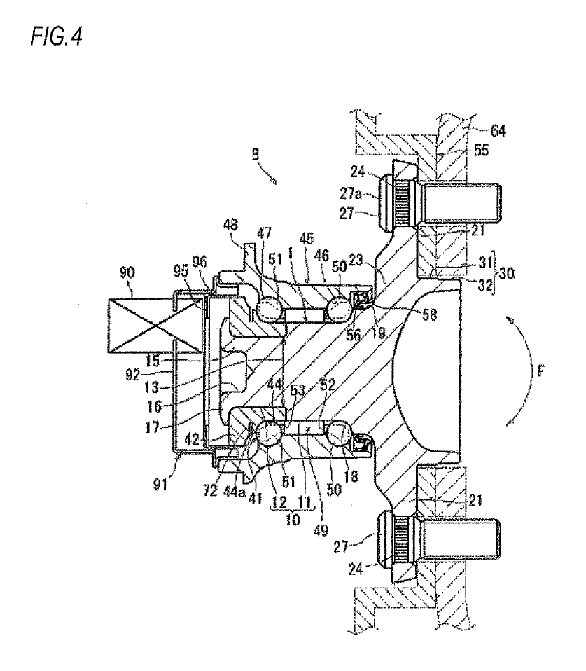

Next, Embodiment 2 according to the present invention will be described referring to FIG. 4.

However, since the basic configuration of a hub spindle bearing unit B for the wheel 60 according to Embodiment 2 is substantially similar to that of the hub spindle bearing unit A for the wheel 60 according to Embodiment 1, the detailed description thereof is omitted.

As shown in FIG. 4, in Embodiment 2, a member where a fragile section is configured is different. In Embodiment 2, a groove section 72 is configured in the inner ring forming annular member 42, instead of the groove section 70 serving as a fragile section formed in the outer ring member 45 in Embodiment 1.

The groove section 72 is formed adjacent to the inner ring shoulder section 44a where the inner ring raceway surface 44 of the inner ring forming annular member 42 is formed, and at the position of the groove section 72 adjacent to the inner ring shoulder section 44a, the inner ring shoulder section 44a is disposed and configured so as to have a thickness so that the inner ring shoulder section 44a is deformed and broken when the excessive shaft bending direction load F is input.

Since the inner ring forming annular member 42 is configured so as to rotate integrally with the hub spindle 1, it is necessary that the groove section 72 is formed by notching around the entire circumference in the circumferential direction at a position adjacent to the inner ring shoulder section 44a where the inner ring raceway surface 44 of the inner ring forming annular member 42 is formed.

With the hub spindle bearing unit B configured as described above, the groove section 72 serving as a fragile section is deformed and broken earlier than the hub spindle 1 when the excessive shaft bending direction load exceeding the load to be input during ordinary use is input to the hub spindle 1, thereby absorbing and relieving the load and being able to provide a configuration in which the shaft bending direction load is not concentrated in the hub spindle 1. As a result, when, among shaft bending direction loads exerted to the hub spindle 1, the excessive shaft bending direction load exceeding the load to be input during ordinary use is exerted, the hub spindle 1 can be suppressed from being broken. In other words, when the excessive shaft bending direction load F is exerted to the balls (rolling elements) rolling on the inner ring raceway surface 44, the balls 51 (rolling elements) are displaced so as to run onto the inner ring shoulder section 44a where the inner ring raceway surface 44 is formed from the regular rolling raceway, whereby the excessive shaft bending direction load F is exerted to the inner ring raceway surface 44. The groove section 72 is configured so as to be formed at the position adjacent to the inner ring shoulder section 44a by paying attention to the displacement of the balls 51 (rolling elements). Hence, the excessive shaft bending direction load F is input to the inner ring raceway surface 44 via the balls 51 (rolling elements), whereby the stress is concentrated at the portion of the outer ring raceway surface 46 and the portion is depressed and deformed. Hence, the inner ring shoulder section 44a is deformed and broken, whereby the inner ring raceway surface 44 is deformed earlier than the hub spindle 1. As a result, the groove section 72 serving as a fragile section can be provided at a more effective position. Furthermore, at the position of the groove section 72 adjacent to the inner ring shoulder section 44a, the inner ring shoulder section 44a is disposed and configured so as to have a thickness so that the inner ring shoulder section 44a is deformed and broken when the excessive shaft bending direction load F is input, whereby the load can be absorbed more effectively. Moreover, as the inner ring shoulder section 44a is deformed and broken, the inner ring raceway surface 44 in this portion is also deformed eventually. As a result, abnormal noise and vibration occur when the balls 51 (rolling elements) roll over the deformed inner ring raceway surface 44. Hence, the user can easily detect that an abnormality has occurred in the hub spindle bearing unit for the wheel. Besides, since the groove section 72 is formed on the side of the inner ring raceway surface 44 of the inner ring forming annular member, instead of the side of the inner ring raceway surface 44 configured on the shaft section itself of the hub spindle 1, the groove section 72 can be machined easily.

Still further, the groove section 72 can be configured in the outer ring and in the inner ring forming annular member 42 without changing the material thereof and without increasing the weight thereof.

### Embodiment 3

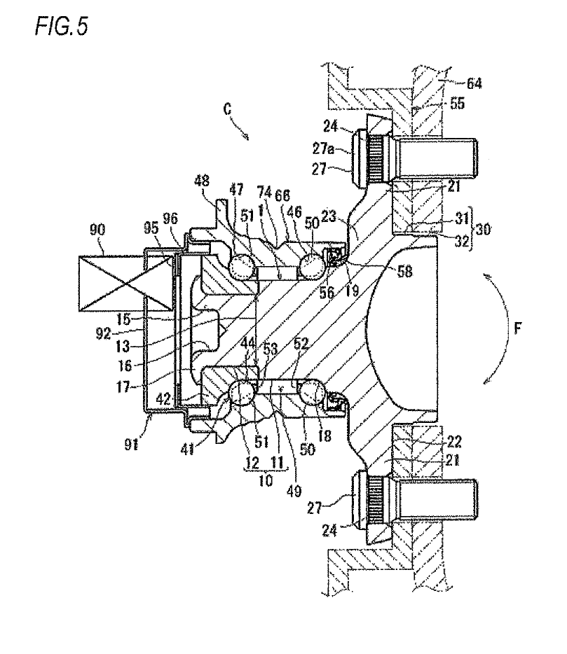

Next, Embodiment 3 according to the present invention will be described referring to FIG. 5.

However, since the basic configuration of a hub spindle bearing unit C for the wheel 60 according to Embodiment 3 is substantially similar to that of the hub spindle bearing unit A for the wheel 60 according to Embodiment 1, the detailed description thereof is omitted.

As shown in FIG. 5, in Embodiment 3, a member where a groove section serving as a fragile section is configured is different.

In Embodiment 3, as in the case of Embodiment 1, a groove section 74 serving as a fragile section is configured in the outer ring, but at a position different from that in Embodiment 1. In Embodiment 3, an outer ring member 66 is configured so as to be used instead of the outer ring member 45 according to Embodiment 1, and the groove section 74 is configured by notching around the entire circumference of the outer peripheral surface of this outer ring member 66 in the circumferential direction. The groove section 74 may be configured by notching at a plurality of places in the circumferential direction at a position adjacent to the outer ring shoulder section 46a where the outer ring raceway surface 46 is formed. In the case that the groove section 74 is formed at a plurality of places, in consideration of the input direction of the shaft bending direction load F, it is preferable that the groove section should be formed at a position corresponding to the up-down direction of a vehicle in a state of being mounted on vehicle body side members, such as a knuckle, a carrier, and the like, supported by a vehicle suspension device.

With the hub spindle bearing unit C configured as described above, the groove section 74 serving as a fragile section is deformed and broken earlier than the hub spindle 1 when the excessive shaft bending direction load F exceeding the load to be input during ordinary use is input to the hub spindle 1, thereby absorbing and relieving the load and being able to provide a configuration in which the shaft bending direction load F is not concentrated in the hub spindle 1. As a result, when, among shaft bending direction loads F exerted to the hub spindle 1, the excessive shaft bending direction load F exceeding the load to be input during ordinary use is exerted, the hub spindle 1 can be suppressed from being broken. Furthermore, in the hub spindle bearing unit C for the wheel 60, with respect to rigidity during ordinary use, since the deformation of the outer ring member 66 in the circumferential direction is dominant, the influence of the groove section 74 formed in the outer peripheral surface of the outer ring member 66 (outer ring) to the rigidity of the outer ring member 66 (outer ring) is small. When the excessive shaft bending direction load F is input, the stress is concentrated in the groove section 74 configured as described above, and the groove section is deformed and broken earlier than the hub spindle 1. As a result, the outer ring member 66 (outer ring) absorbs and relieves the excessive shaft bending direction load F, thereby being able to provide a configuration in which the load F is not concentrated in the hub spindle 1. In addition, the groove section 74 can be configured in the outer ring member 66 (outer ring) without changing the material thereof and without increasing the weight thereof.

Although Embodiments 1 to 3 according to the present invention have been described above, the hub spindle bearing unit for the wheel according to the present invention is not limited to the embodiments, but can be embodied in other various modes.

For example, in Embodiments 1 to 3, although the above description has been made with respect to a driven wheel, the hub spindle bearing unit for the wheel according to the present invention has a configuration also applicable to a drive wheel. For example, the configuration may be applicable to a drive wheel which is equipped with the outer joint member of a constant-velocity universal joint constituting a part of a drive shaft, a hub spindle having a flange section for mounting a wheel, and a double row roller bearing, these being formed into a unit.

### INDUSTRIAL APPLICABILITY

With the present invention, in the hub spindle bearing unit for the wheel in which the shaft section of the hub spindle integrated with the flange section capable of mounting a wheel is supported by a supporting member via the bearing, when, among shaft bending direction loads exerted to the hub spindle, the excessive shaft bending direction load exceeding the load to be input during ordinary use is exerted, the hub spindle can be suppressed from being broken.

This application is based upon Japanese Patent Application No. 2011-025979 filed on Feb. 9, 2011, the entire contents of which are incorporated herein by reference.

### DESCRIPTION OF REFERENCE NUMERALS AND SIGNS

1 hub spindle
10 shaft section
11 large-diameter section of shaft section
12 small-diameter section of shaft section
15 end shaft section of shaft section
16 shaft end concave section
17 calked section
18 inner ring raceway surface
19 sealing surface
21 flange section
23 flange base section
24 bolt hole
27 hub bolt
30 fitting shaft section
31 brake rotor fitting section
32 wheel fitting section
41 angular contact ball bearing
42 inner ring forming annular member
44 inner ring raceway surface
44a inner ring shoulder section
45 outer ring member
46 outer ring raceway surface
46a outer ring shoulder section
47 outer ring raceway surface
47a outer ring shoulder section
48 vehicle body side flange
49 annular space
52 cage
53 cage
55 brake rotor
56 sealing member
58 lip
60 wheel
62 tire
64 wheel element
66 outer ring member
70 groove section
72 groove section
74 groove section
A hub spindle bearing unit
B hub spindle bearing unit
C hub spindle bearing unit

1. A hub spindle bearing unit for a wheel in which a shaft section of a hub spindle integrated with a flange section capable of mounting the wheel is supported by a supporting member via a bearing, wherein
the bearing of the shaft section of the hub spindle includes:
an inner ring having inner ring raceway surfaces formed on an outer peripheral surface of the shaft section itself or an inner ring forming annular member formed separately from the shaft section and mounted on the shaft section;
an outer ring having outer ring raceway surfaces formed corresponding to the inner ring raceway surface formed on the inner ring; and
rolling elements rotatably disposed between the inner ring raceway surfaces of the inner ring and the outer ring raceway surfaces of the outer ring,
a fragile section in which a strength against a shaft bending direction load exerted to the hub spindle is weaker than a strength of the hub spindle is formed in at least one of the outer ring and the inner ring forming annular member, and
the fragile section is deformed and broken earlier than the hub spindle when an excessive shaft bending direction load exceeding a load to be input during ordinary use is input to the hub spindle.

2. The hub spindle bearing unit for the wheel according to claim 1, wherein
the fragile section formed in at least one of the outer ring and the inner ring forming annular member is configured as a groove section at a plurality of places or around an entire circumference in a circumferential direction.

3. The hub spindle bearing unit for the wheel according to claim 2, wherein
the groove section is formed adjacent to an outer ring shoulder section on which the outer ring raceway surface of the outer ring is formed, and
a position of the groove section adjacent to the outer ring shoulder section is disposed and configured so that the outer ring shoulder section has a thickness so as to be deformed and broken by an input of the excessive shaft bending direction load.

4. The hub spindle bearing unit for the wheel according to claim 3, wherein
the groove section configured in the outer ring is formed adjacent to the outer ring shoulder section where, out of the outer ring raceway surfaces of the outer ring, the outer ring raceway surface disposed and configured on a side of the flange section of the hub spindle is formed.

5. The hub spindle bearing unit for the wheel according to claim 2, wherein
the groove section is formed adjacent to an inner ring shoulder section on which the inner ring raceway surface of the inner ring forming annular member is formed, and
a position of the groove section adjacent to the inner ring shoulder section is disposed and configured so that the inner ring shoulder section has a thickness so as to be deformed and broken by an input of the excessive shaft bending direction load.

6. The hub spindle bearing unit for the wheel according to claim 2, wherein
the groove section is formed in an outer peripheral surface of the outer ring.
